(19) United States
(12) Patent Application Publication
(10) Pub. No.: US 2009/0299838 A1
(43) Pub. Date: Dec. 3, 2009

(54) Method of giving through advertising publication

(76) Inventor: Colleen Mary Read, Gulfport, MS (US)

Correspondence Address: Colleen M. Read, 614 McIntosh Street, Gulfport, MS, 39507, US

(21) Appl. No.: 12/454,870

(22) Filed: May 26, 2009

Related U.S. Application Data
(60) Provisional application No. 61/128,770, filed on May 23, 2008.

(51) Int. Cl. G06Q 30/00

(52) U.S. Cl. 705/14.5

(57) ABSTRACT

This business method creates a business model that creates a publication used as an information vehicle that converts pre-owned consumer goods into for profit revenue with a portion of the revenues donated to legitimate 501(c)3 organizations.

The present invention is a method of using a classified advertising publication to generate charitable donations from individuals' classified advertisements and commercial business advertisements.

The art centers around the concept of a classified publication that contains unique art and articles relating to issues that are critical to the health of the earth and mankind. The for profit publication is designed for multiple charitable organizations on a local and international scale.

This application claims benefit of provisional application Ser. No. 61/128,770 filed May 23, 2008

A locally produced publication is used to increase donor giving and awareness using classified advertisements for the sale of pre-owned items sold for a profit with a specified percent amount dedicated as a donation from revenues obtained for such a sale of times to the general public.

As sellers designate the percentage given from the sale to a donor selected charity prior to publication of the advertisement and listed within the publication as advertisement for both the items being sold and the charity receiving the charity.

Each local publication is to provide a visual picture of the logo of the charity and its base of operations. Occasional special events will highlight Charity organization and the cause being provided for as a key to donor involvement.

A “virtual garage sale” wherein charities' donor lists are used to solicit items that are listed sale for profit as a classified advertising denoting; the receiving charities along with the items being sold.

In addition to the revenues donated for charitable support through the classified portion of this publication, [a] donor selected (no less than 10 percent) of the revenues from the sale of commercial advertisers will be donated to the monthly featured charity.

### DESCRIPTION OF DRAWING

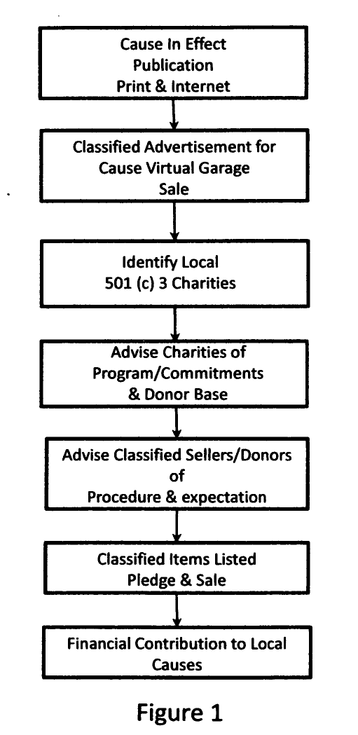

FIG. 1. demonstrates the business to develop a “for profit business model denoted as “Cause in Effect” is created to publish a website and print publication following the following steps. The medial will;
a. Cause in Effect contracts individuals in a plurality of geographical locations with a for profit business opportunities working with Cause in Effect a media publication network;
b. Advertise in local publications and on a website that will be set up for Classified Advertisements for Cause in Effect Virtual Garage Sale to educate selling public and organizations having property for sale and about Cause in Effect donation opportunities.
c. Identify Local 501 (c) 3 Charities locally situated and educate them about donation and advertisement opportunities available with publication.
d. Contact local certified charities about Cause in Effect mission and donation opportunities.
e. Advertise in the local geographical area to promote and educate the selling public and potential paid advertisers about publication and charity promotion.
f. Obtain classified items advertisements and donation pledges from sellers.
g. Orchestrate financial contributions to local charitable causes.

I claim:

1. A method of business that promotes philanthropic promotion and giving that provides both the selected charities and donors with a publication vehicle used to promote financial giving to a qualified charitable organization in support of community programs; comprised of the following:
a. identify legitimate local charitable organizations; for publication in a “classified for cause” advertising section within the publication of a virtual garage sale;
b. promoting the classified advertisement of virtual garage items for profitable sale with a portion of profits dictated to donation to said charitable community causes;
c. advise classified sellers/donors items with said profits and attention directed to charitable organizations with a contribution expectation;
d. classified advertising and selling business with pledged commitments upon sales;
e. giving a portion of the donor profits to a donor-advised charity; to benefiting the charitable organization with proceeds of the classified and business ad sales.

2. A method of claim 1, wherein the step of selecting local publicly supported not for profit organizations to lend exposure and generating funds.

3. A method of claim 1, further comprising;
creating a classified advertisement within an information publication to host virtual garage sales items to support said charitable causes.

4. A method of claim 3, further comprising;
a specific venue for charities, donors and advertisers to sell their wares and contribute to cause.

5. A method of claim 1, further comprising;
a locally printed publication in plurality of geographical markets, and complimented with an online version.

6. A method to claim 1, further comprising;
a contribution back to participating charities through all publication sales.

7. A method of claim 1, wherein a multiple purpose publication vehicle is used to advance community awareness of environmental, social, and community education and art awareness projects, accomplishments, and progress of local efforts of charitable organizations projects and activities.
